(19) United States
(12) Patent Application Publication
(10) Pub. No.: US 2014/0098688 A1
(43) Pub. Date: Apr. 10, 2014

(54) OUTER LOOP CONTROL OF CQI REPORTING AND GENERATION IN WIRELESS NETWORK

(71) Applicant: QUAL COMM Incorporated, San Diego, CA (US)

(72) Inventors: Insung KANG, San Diego, CA (US); Surendra BOPPANA, San Diego, CA (US); Aamod Dinkar KHANDEKAR, San Diego, CA (US); Vishwajeet POTNIS, San Diego, CA (US)

(73) Assignee: QUAL COMM Incorporated, San Diego, CA (US)

(21) Appl. No.: 14/027,898

(22) Filed: Sep. 16, 2013

Related U.S. Application Data
(60) Provisional application No. 61/712,070, filed on Oct. 10, 2012.

(51) Int. Cl. H04L 1/00

(52) U.S. Cl. CPC H04L 1/0026
USPC 370/252

(57) ABSTRACT

An outer loop for channel quality metric estimation may analyze channel realization and perform adaptive averaging to correct for an inner loop bias. The outer loop may take into account varying channel conditions and may adjust a reported channel quality metric up or down depending on throughput.

### CROSS-REFERENCE TO RELATED APPLICATION

This application claims the benefit under 35 U.S.C. §119(e) to U.S. Provisional Patent Application No. 61/712,070 entitled “OUTER LOOP CONTROL OF CQI REPORTING AND GENERATION IN TD-SCDMA,” filed on Oct. 10, 2012, in the names of Kang, et al., the disclosure of which is expressly incorporated by reference herein in its entirety.

### BACKGROUND

1. Field

Aspects of the present disclosure relate generally to wireless communication systems, and more particularly, to outer loop control of channel quality index (CQI) reporting and generation in a wireless network, such as a TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

Offered is a method of wireless communication. The method includes determining an observed block error rate (BLER) for received transmissions. The method also includes adjusting a channel quality reporting metric based at least in part on the observed BLER to approach a target BLER, the channel quality reporting metric being based at least in part on a spectral efficiency metric.

Offered is an apparatus for wireless communication. The apparatus includes means for determining an observed block error rate (BLER) for received transmissions. The apparatus also includes means for adjusting a channel quality reporting metric based at least in part on the observed BLER to approach a target BLER, the channel quality reporting metric being based at least in part on a spectral efficiency metric.

Offered is a computer program product configured for operation in a wireless communication network. The computer program product includes a non-transitory computer-readable medium having non-transitory program code recorded thereon. The program code includes program code to determine an observed block error rate (BLER) for received transmissions. The program code also includes program code to adjust a channel quality reporting metric based at least in part on the observed BLER to approach a target BLER, the channel quality reporting metric being based at least in part on a spectral efficiency metric.

Offered is an apparatus configured for operation of a multi-radio user equipment (UE) in a wireless communication network. The apparatus includes a memory and a processor(s) coupled to the memory. The processor(s) is configured to determine an observed block error rate (BLER) for received transmissions. The processor(s) is also configured to adjust a channel quality reporting metric based at least in part on the observed BLER to approach a target BLER, the channel quality reporting metric being based at least in part on a spectral efficiency metric.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a block diagram illustrating a signal-to-interference value adjustment according to one aspect of the present disclosure.

FIG. 5 is a block diagram illustrating a method for outer loop control of channel quality index (CQI) reporting and generation according to one aspect of the present disclosure.

FIG. 6 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

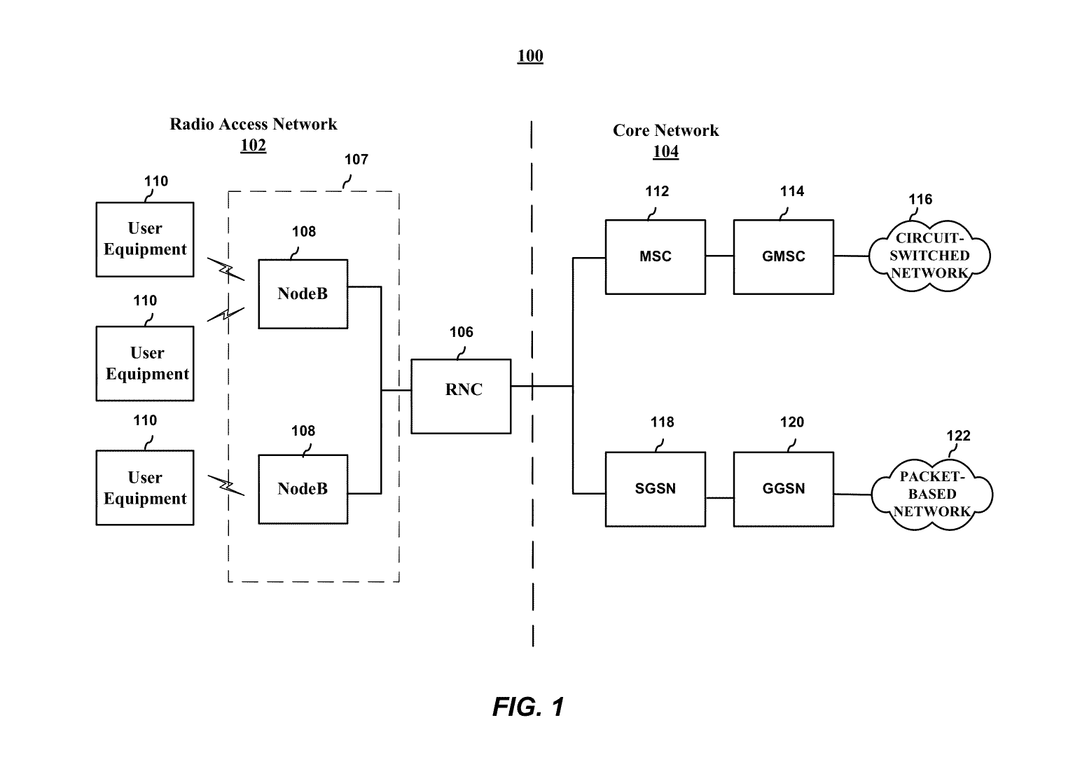

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

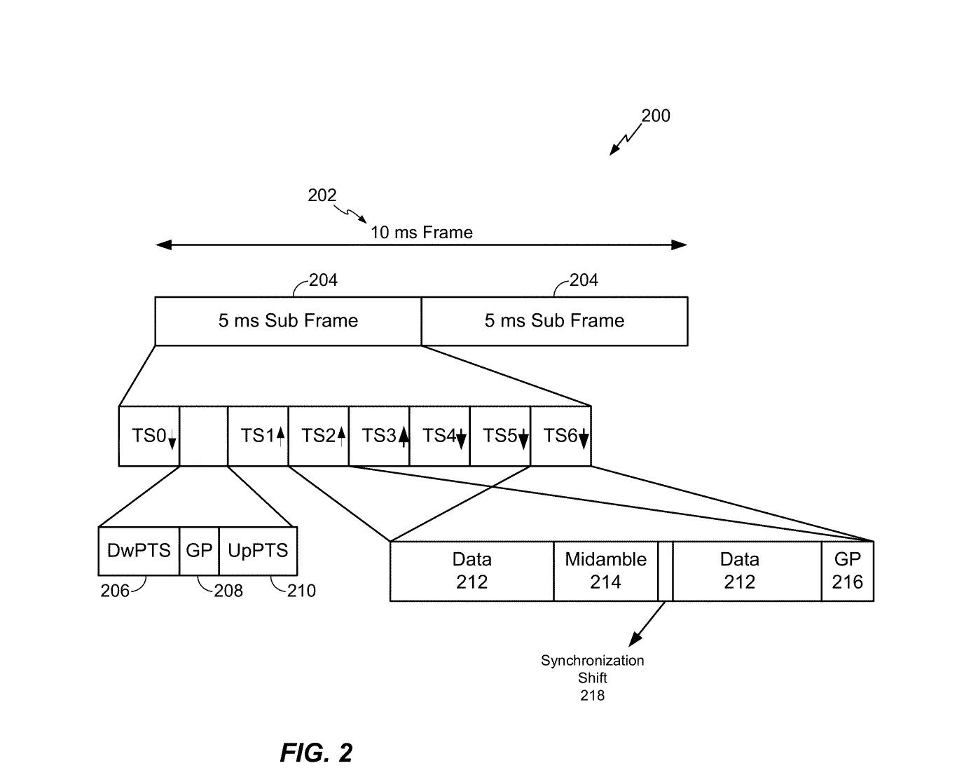

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. SS bits 218 only appear in the second part of the data portion. The SS bits 218 immediately following the midamble can indicate three cases: decrease shift, increase shift, or do nothing in the upload transmit timing. The positions of the SS bits 218 are not generally used during uplink communications.

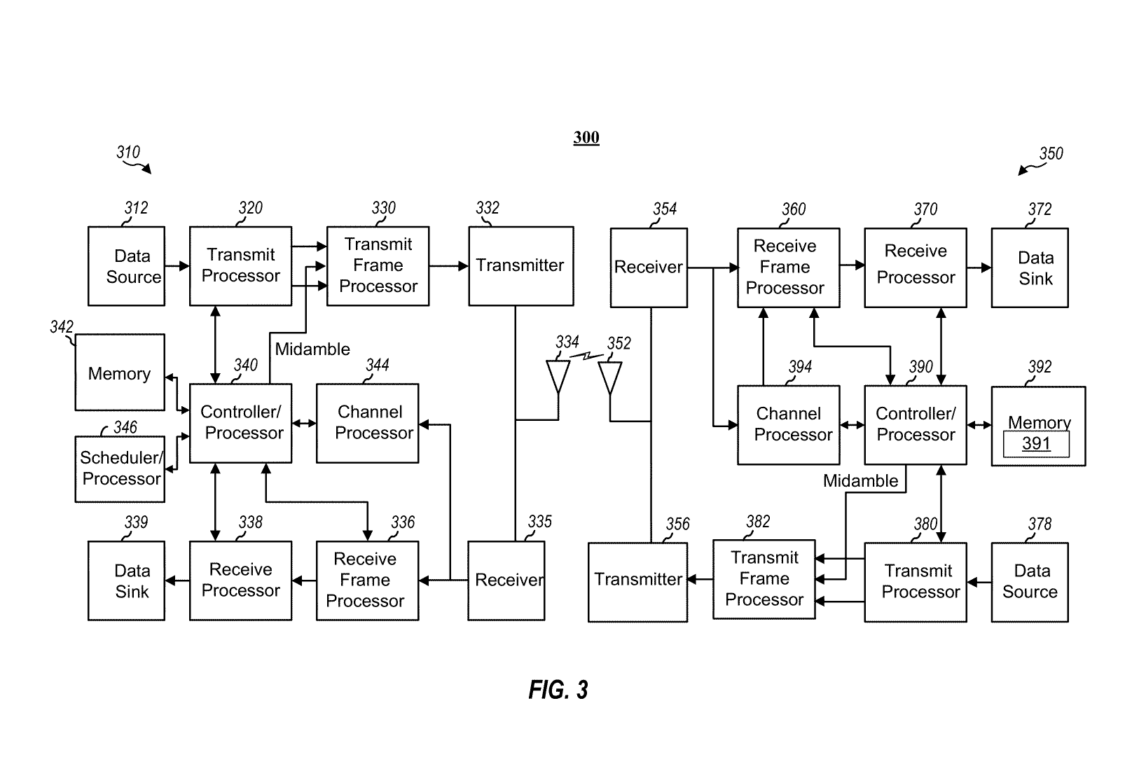

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store an outer loop control CQI generation module 391 which, when executed by the controller/processor 390, configures the UE 350 for determining an expected synchronization channel code word based on the operating frequency and base station identification code of a base station. A scheduler/processor 346 at the node B 310 may be used to allocate resources to the UEs and schedule downlink and/or uplink transmissions for the UEs.

### Outer Loop Control of Cqi Reporting and Generation

A user equipment (UE) reports a channel quality index (CQI) of a downlink (DL) High Speed-Physical Downlink Shared Channel (HS-PDSCH) to a base station to inform the base station of the quality of downlink communications between the base station and the UE. A CQI report may include a recommended modulation format (RMF), and a recommended transport block (TB) size (RTBS). The CQI report may be carried on the High-Speed Shared Information Channel (HS-SICH).

Techniques for determining a CQI report based on a spectral efficiency metric are discussed in co-pending patent application Ser. No. ______, in the names of ______, filed on ______(Attorney Docket Number 124703) and in U.S. provisional patent application 61/711,658 entitled “CQI REPORTING AND GENERATION IN TD-SCDMA,” filed on Oct. 9, 2012 in the names of Khandekar, et al., the disclosures of which are expressly incorporated herein by reference in their entireties.

An inner loop may estimate the CQI to report based on signal to interference ratio (SIR)/spectral efficiency (SE) or other factors. The UE may then send a determined RMF and RTBS, which comprise the CQI, to a base station. If a channel is encountered with varying channel conditions, a UE may report a CQI that relies on incorrect channel conditions and does not account for the actual throughput capable on a channel. To correct for inner loop biases that may lead to degradation, an outer loop may be implemented for channel quality index (CQI) estimation.

An outer loop for CQI estimation may analyze channel realization and perform adaptive averaging to correct for an inner loop bias. The outer loop may analyze statistics for acknowledgements/negative-acknowledgements (ACKs/NACKs) for received data and adjust an inner loop CQI estimation up or down as a result of this analysis. The ACK/NACK statistics may correspond to new transmissions rather than retransmissions. The outer loop may then generate an adjustment to a signal-to-interference ratio (SIR) (SIR_{Adj}) based on a cyclic redundancy check (CRC) of a received packet. The inner loop's SIR value may then be adjusted by the adjustment value provided by the outer loop. The outer loop is optional, and may be disabled (for example, by setting SIR_{Adj}=0) if desired. The outer-loop CQI (OL-CQI) may control spectral efficiency (SE) filtering in the inner loop CQI (IL-CQI).

As part of the determination of SIR_{Adj}, the UE may convert a spectral efficiency metric determined by the inner loop, such as SE_{avg} into a signal-to-interference ratio (SIR) value. That SIR value may then be adjusted by SIR_{Adj} and converted back to arrive at SE_{adj}. The RMF choice may be based on the value of SE_{adj}. SE_{adj} may be converted to a code rate (for example using a look up table) and the code rate may be converted to a RTBS value based on the resources allocated to a UE. The determinations of RMF and RTBS may be performed as detailed in the applications incorporated by reference above. The values of RMF and RTBS may then be incorporated into a CQI report and reported to a base station.

In one aspect, the outer loop may base the value of SIR_{Adj} on a target block error rate (BLER_{TARGET}). The calculation of BLER may be based on new transmissions. After a period of no high speed (HS) transmissions (e.g., the last ‘M’ subframes), the SIR_{Adj} may be reset to 0. After a new transmission is received in a subframe, the SIR_{Adj} may be adjusted. The outer loop may calculate the adjustment value to push the inner loop to achieve the BLER_{TARGET}. Every time there is a transmission, the outer loop may determine if information was correctly received in a particular subframe (indicated by a CRC pass) or not (indicated by a CRC fail). If the data was not correctly received, the SIR_{Adj} is adjusted by a certain step size (Δ_{DOWN}). If the data was correctly received, the SIR_{Adj} is adjusted by a smaller amount based on the BLER_{TARGET}. The value of SIR_{Adj} may be held to be within a certain value range. The following equations illustrate these adjustments to SIR_{Adj}:

$${SIR}_{Adj} = {SIR}_{Adj} - {Δ}_{DOWN}$$

$$CRC fail$$

$${SIR}_{Adj} = {SIR}_{Adj} - {Δ}_{DOWN} \frac{{BLER}_{TARGET}}{1 - {BLER}_{TARGET}}$$

$$CRC pass$$

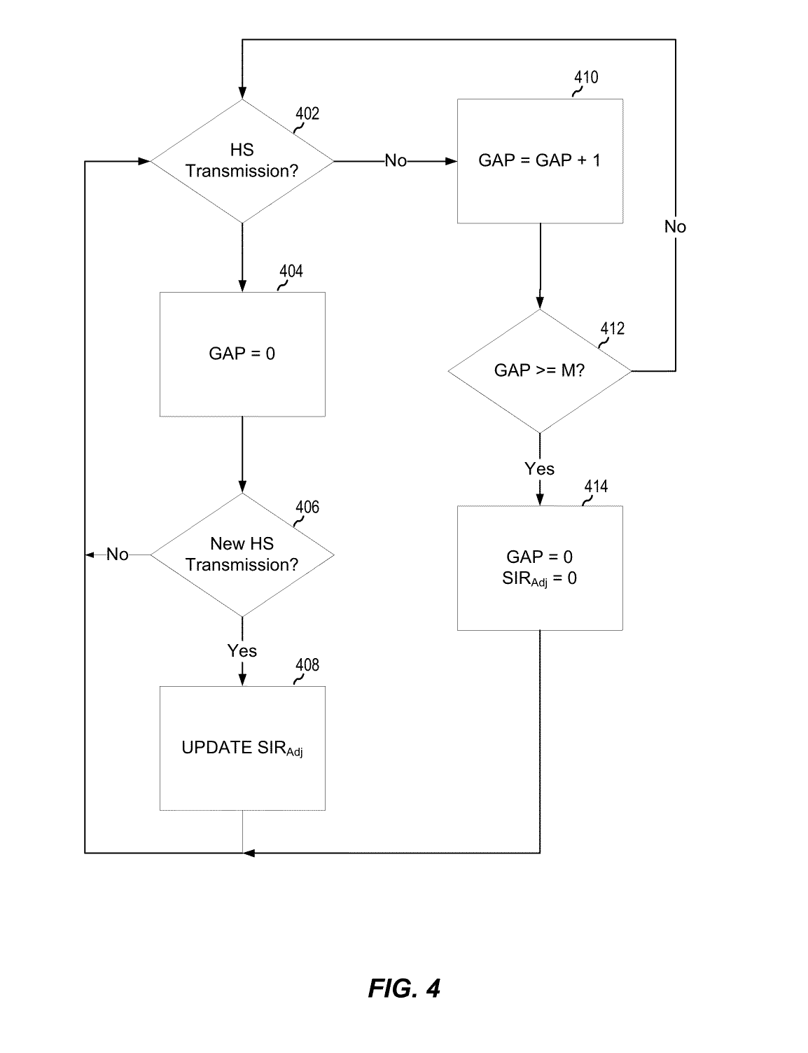

FIG. 4 illustrates calculation of SIR_{Adj} according to one aspect of the present disclosure. If no high speed (HS) transmission is received in a subframe (checked in block 402), resulting in a gap in transmissions, a counter (GAP) which keeps track of the value of the number of subframes without a transmission, may be increased (shown in block 410). If the counter number equals or exceeds a certain threshold (for example, M subframes) (checked in block 412), the value of SIR_{Adj} may be reset along with the value for the counter (shown in block 414).

If the gap threshold has not been reached, the value of SIR_{Adj} may remain unchanged and a search for high speed transmission continues. If a high speed transmission is received in a subframe, the counter may be reset (shown in block 404) and a check made to see if the high speed transmission is a new high speed transmission or a high speed retransmission (check shown in block 406). If a high speed retransmission is received in a subframe, the value of SIR_{Adj} may not be adjusted and a search for high speed transmission continues. If the high speed transmission is a new transmission the value of SIR_{Adj} may be adjusted, for example using the equations above, as seen in block 408.

A filter state of a spectral efficiency (SE) metric (such as discussed in the applications incorporated by reference) may be reset under certain conditions. The UE may monitor High Speed-Physical Downlink Shared Channel (HS-PDSCH) transmissions every subframe, including new transmissions and retransmissions. If there are no HS-PDSCH transmissions over a certain period of time (e.g., the last K subframes) a command may be sent to reset the content and state of the inner loop to avoid the inner loop becoming stale. Enabling/disabling of SIR_{Adj} by the outer loop may be independent of the SE metric filter reset.

When a new transmission is received in a subframe, an estimated BLER may be updated using a single pole infinite impulse response (IIR) filter. The calculations for an observed BLER for a particular subframe (n) may be stated as follows:

BLER_{calc}(n)=(1−α)BLER_{calc}(n−1)+αδ(n),

where δ(n)=1 if CRC fails or 0 if CRC pass.

where alpha is a weighting factor. The filter and SIR_{Adj} may be adjusted if no high speed transmission is received for M consecutive subframes. Further, if a burst of CRC failures is detected, an exit condition may be implemented where the step size value of Δ_{DOWN} is set to a largest size.

The value of the step size Δ_{DOWN} may be determined as a function of a difference between the observed BLER (BLER_{calc}) and BLER_{TARGET}. This value may be chosen using the following tables:

TABLE 1

| BLER_{calc}-BLER_{TARGET} > 0 | Step Size (Δ_{DOWN}) |
|---|---|
| 0-2% | 0.0 dB |
| 2-10% | 0.1 dB |
| 10-20% | 0.2 dB |
| 20-30% | 0.3 dB |
| 30-40% | 0.4 dB |
| >40% | 0.5 dB |

TABLE 2

| BLER_{TARGET}-BLER_{calc} > 0 | Step Size (Δ_{DOWN}) |
|---|---|
| 0-2% | 0.0 dB |
| 2-5% | 0.2 dB |
| 5-10% | 1.0 dB |
| 10-20% | 1.0 dB |
| 20-30% | 1.0 dB |
| 30-40% | 1.0 dB |
| >40% | 1.0 dB |

TABLE 1 may be used when the difference between BLER_{calc} and BLER_{TARGET} is positive. TABLE 2 may be used when the difference between BLER_{calc} and BLER_{TARGET} is negative. As illustrated, if an error rate is high, a SIR may be adjusted quickly (with a large step size) to lower throughput quickly and thus reduce errors.

In an alternate aspect, a modified outer loop may focus on improving throughput. In this alternate outer loop, a CQI table has multiple candidate entries for code rates for each value of a calculated SE metric. The table may be updated dynamically. A single set of candidate code rates may be maintained across all possible channel allocations of the HS-PDSCH, or candidate code rates may be maintained separately for each group of HS-PDSCH resource allocations. Grouping may be based on the total number of physical channel bits in the allocation. Each code rate entry may also have an associated BLER value, which indicates the performance of the particular code rate. The associated BLER values may be updated by the outer loop to maintain correct throughput associations for the code rates. For the CQI report, the desired code rate is chosen to improve expected throughput.

A CQI lookup table may have 64 different entries that correspond to different values of a SE metric. These values may be mapped to a certain code rate/recommended transport block size (RTBS) that is desired in Additive White Gaussian Noise (AWGN). The outer loop may extend this table by adding additional columns for each entry of SE (RTBS+1, RTBS−1, RTBS−2, . . . etc.) and associated BLER values. The UE may also store code rates in addition to or instead of RTBS.

For an incoming message, the code rate and the effective SE (SEeff) may be calculated and the BLER for the (code rate, SE_{eff}) pair in the table is updated based on whether the packet was received correctly (CRC pass) or incorrectly (CRC fail) using the equation:

BLER=(1−αBLER)*BLER+αBLER*CRC

where CRC=0 if pass, 1 if fail

where α is a weighting factor. If the message is an ACK, then the BLER for the code rate as well as the BLER for all the code rates below are updated with a pass. If the message is an NACK, then the BLER for the code rate as well as the BLER for all the code rates above are updated with a fail. ACK/NACK considerations are for new transmissions.

During transmission of the CQI report, the code rate is then chosen to improve expected throughput (TPUT) for each candidate code rate.

TPUT=(1−BLER)*RTBS+BLER*coderate/2

The RTBS may be derived by multiplying the code rate and the physical channel resources (i.e., bits) allocated to the HS-PDSCH. The candidate code rate (and/or RTBS) associated with the highest calculated TPUT may be reported as part of a channel quality metric (such as a CQI report). Other suitable cost functions may also be used to find the desired coderate/RTBS. In this way, the best value of RTBS from multiple candidate RTBS values may be selected to improve throughput.

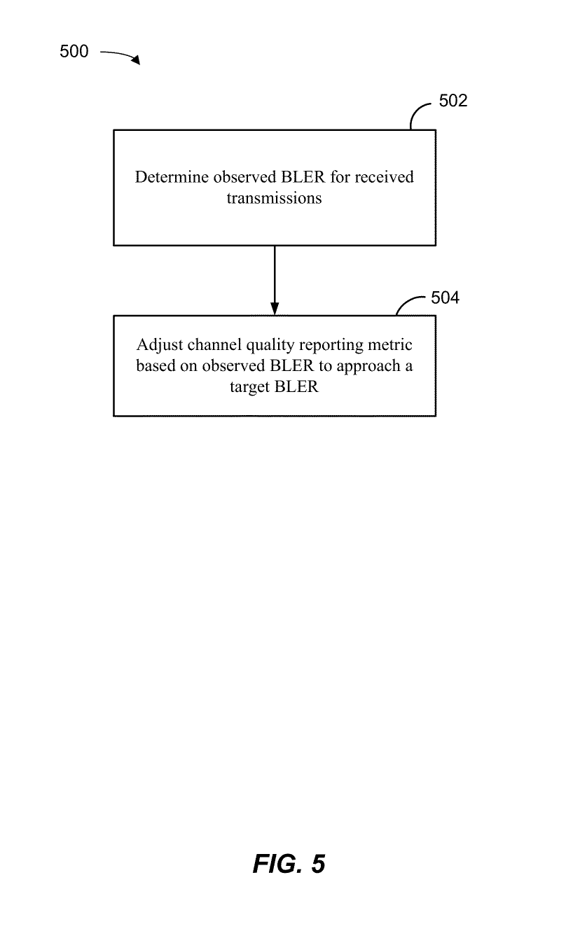

FIG. 5 shows a wireless communication method according to one aspect of the disclosure. A UE may determine an observed block error rate (BLER) for received transmissions, as shown in block 502. The UE may adjust a channel quality reporting metric based on the observed BLER to approach a target BLER, as shown in block 504. The CQI metric may be based at least in part on a spectral efficiency metric.

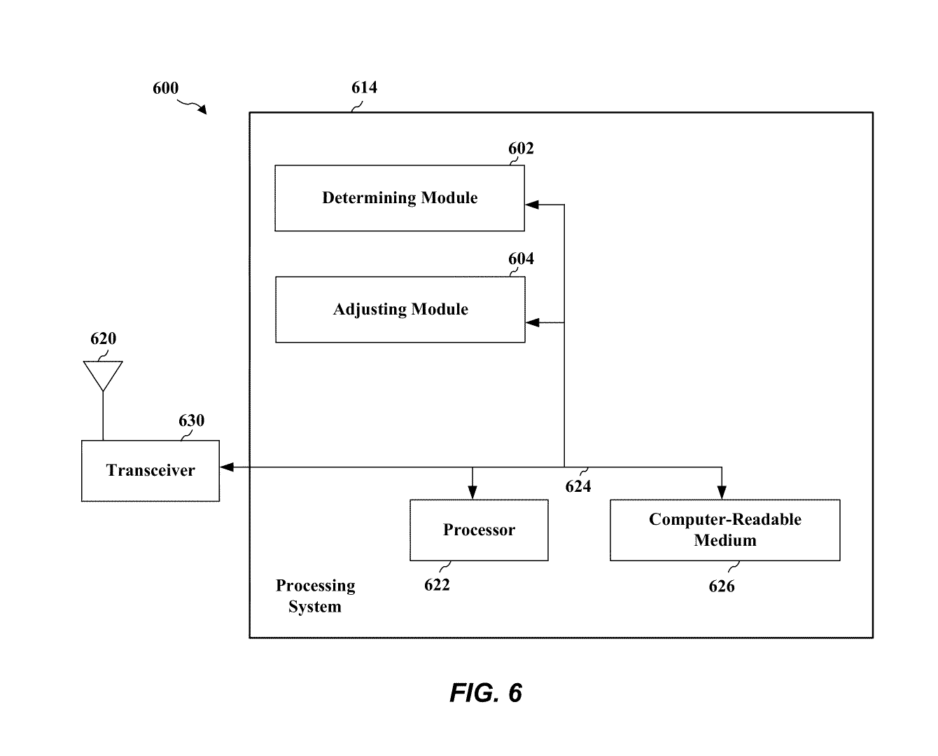

FIG. 6 is a diagram illustrating an example of a hardware implementation for an apparatus 600 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 622 the modules 602 and 604, and the computer-readable medium 626. The bus 624 may also link various other circuits such as timing sources, peripherals, voltage regulators, and power management circuits, which are well known in the art, and therefore, will not be described any further.

The apparatus includes a processing system 614 coupled to a transceiver 630. The transceiver 630 is coupled to one or more antennas 620. The transceiver 630 enables communicating with various other apparatus over a transmission medium. The processing system 614 includes a processor 622 coupled to a computer-readable medium 626. The processor 622 is responsible for general processing, including the execution of software stored on the computer-readable medium 626. The software, when executed by the processor 622, causes the processing system 614 to perform the various functions described for any particular apparatus. The computer-readable medium 626 may also be used for storing data that is manipulated by the processor 622 when executing software.

The processing system 614 includes a determining module 602 for determining an observed block error rate (BLER). The processing system 614 includes an adjusting module 604 for adjusting a channel quality metric. The modules may be software modules running in the processor 622, resident/stored in the computer-readable medium 626, one or more hardware modules coupled to the processor 622, or some combination thereof. The processing system 614 may be a component of the UE 350 and may include the memory 392, and/or the controller/processor 390.

In one configuration, an apparatus such as a UE is configured for wireless communication including means for observing. In one aspect, the above means may be the controller/processor 390, the memory 392, an outer loop control CQI generation module 391, determining module 602, antennae 352, receiver 354, and/or the processing system 614 configured to perform the functions recited by the aforementioned means. In another aspect, the aforementioned means may be a module or any apparatus configured to perform the functions recited by the aforementioned means.

In one configuration, an apparatus such as a UE is configured for wireless communication including means for adjusting. In one aspect, the above means may be the controller/processor 390, the memory 392, an outer loop control CQI generation module 391, adjusting module 604, and/or the processing system 614 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining an observed block error rate (BLER) for received transmissions; and
adjusting a channel quality reporting metric based at least in part on the observed BLER to approach a target BLER, the channel quality reporting metric being based at least in part on a spectral efficiency metric.

2. The method of claim 1, further comprising generating the spectral efficiency metric based at least in part on a data channel.

3. The method of claim 1, in which the adjusting comprises adjusting a reported signal-to-interference ratio (SIR) on which the channel quality reporting metric is based, the SIR being based at least in part on the spectral efficiency metric.

4. The method of claim 3, in which the SIR is adjusted based at least in part on a cyclic redundancy check of a received packet.

5. The method of claim 3, in which the SIR is adjusted based at least in part on the target BLER.

6. The method of claim 1, in which the adjusting comprises adjusting the spectral efficiency metric on which the channel quality reporting metric is based.

7. The method of claim 1, further comprising:
maintaining a plurality of candidate code rates; and
dynamically selecting one of the candidate code rates to improve a performance metric.

8. The method of claim 7, further comprising dynamically computing the performance metric based at least in part on the spectral efficiency metric and the observed BLER.

9. The method of claim 8, further comprising generating the channel quality reporting metric based at least in part on a transmitted code rate.

10. The method of claim 7, in which the performance metric is throughput.

11. An apparatus for wireless communication, comprising:
means for determining an observed block error rate (BLER) for received transmissions; and
means for adjusting a channel quality reporting metric based at least in part on the observed BLER to approach a target BLER, the channel quality reporting metric being based at least in part on a spectral efficiency metric.

12. A computer program product configured for operation in a wireless communication network, the computer program product comprising:
a non-transitory computer-readable medium having non-transitory program code recorded thereon, the program code comprising:
program code to determine an observed block error rate (BLER) for received transmissions; and
program code to adjust a channel quality reporting metric based at least in part on the observed BLER to approach a target BLER, the channel quality reporting metric being based at least in part on a spectral efficiency metric.

13. An apparatus configured for operation of a multi-radio user equipment (UE) in a wireless communication network, the apparatus comprising:
a memory; and
at least one processor coupled to the memory, the at least one processor being configured:
to determine an observed block error rate (BLER) for received transmissions; and
to adjust a channel quality reporting metric based at least in part on the observed BLER to approach a target BLER, the channel quality reporting metric being based at least in part on a spectral efficiency metric.

14. The apparatus of claim 13, in which the at least one processor is further configured to generate the spectral efficiency metric based at least in part on a data channel.

15. The apparatus of claim 13, in which the at least one processor is configured to adjust the channel quality reporting metric by adjusting a reported signal-to-interference ratio (SIR) on which the channel quality reporting metric is based, the SIR being based at least in part on the spectral efficiency metric.

16. The apparatus of claim 15, in which the at least one processor is configured to adjust the SIR based at least in part on a cyclic redundancy check of a received packet.

17. The apparatus of claim 15, in which the at least one processor is configured to adjust the SIR based at least in part on the target BLER.

18. The apparatus of claim 13, in which the at least one processor is configured to adjust the channel quality reporting metric by adjusting the spectral efficiency metric on which the channel quality reporting metric is based.

19. The apparatus of claim 13, in which the at least one processor is further configured:
to maintain a plurality of candidate code rates; and
to dynamically select one of the candidate code rates to improve a performance metric.

20. The apparatus of claim 19, in which the at least one processor is further configured to dynamically compute the performance metric based at least in part on the spectral efficiency metric and the observed BLER.

21. The apparatus of claim 20, in which the at least one processor is further configured to generate the channel quality reporting metric based at least in part on a transmitted code rate.

22. The apparatus of claim 19, in which the performance metric is throughput.
